(19) United States
(12) Patent Application Publication
(10) Pub. No.: US 2016/0229613 A1
(43) Pub. Date: Aug. 11, 2016

(54) PACKAGE AND METHOD FOR MANUFACTURING THE SAME

(71) Applicant: MOROFUJI Inc., Chikushino-shi, Fukuoka (JP)

(72) Inventor: Toshiro MOROFUJI, Chikushino-shi, Fukuoka (JP)

(73) Assignee: MOROFUJI Inc., Chikushino-shi, Fukuoka (JP)

(21) Appl. No.: 14/782,938

(22) PCT Filed: Oct. 17, 2014
(86) PCT No.: PCT/JP2014/077679

§ 371 Date: Oct. 7, 2015

(30) Foreign Application Priority Data
Aug. 11, 2014 (JP) 2014-163889

(51) Int. Cl. B65D 75/56; B31B 29/60; B31B 1/86; B65D 75/58; B31B 1/64

(52) U.S. Cl. CPC B65D 75/566; B65D 75/58; B31B 1/64; B31B 1/86; B31B 29/60

(57) ABSTRACT

Provided is a package which can be quickly and simply brought into a three-dimensional shape from a folded state to hold a drink cup or the like and is also not bulky in storage before use, and a method for manufacturing the same.

A package P1 includes a bag main body 1 folded flat, having a gusset portion 10 at a bottom portion, and having an inlet 11 at a side opposite to the gusset portion 10 and a holder sheet 2 folded flat, provided in parallel with the gusset portion 10 at a position close to the bottom portion and separated from the gusset portion 10 in an interior of the bag main body 1, and having a single or plurality of holding openings 21 and 21a, and can be quickly and simply brought into a three-dimensional shape from a folded state to hold a drink cup or the like and is also not bulky in storage before use.

### TECHNICAL FIELD

The present invention relates to a package and a method for manufacturing the same. More specifically, the present invention relates to a package which can be quickly and simply brought into a three-dimensional shape from a folded state to hold a drink cup or the like and is also not bulky in storage before use, and a method for manufacturing the same.

### BACKGROUND ART

When taking out a cup-filled drink such as coffee sold at a convenience store or the like, in order to prevent the cup from tilting or falling over to spill the contents, an assembling-type packaging carrier formed of cardboard, thin corrugated cardboard, or the like is placed in a packaging bag such as a plastic bag, and the cup is placed and held in a holding part of the packaging carrier for allowing take-out.

Such packaging carriers include “a cup holder” disclosed in, for example, Patent Document 1. This cup holder is made of paper and structured to be assembled with a sheet cut into a predetermined shape and brought into a three-dimensional shape.

### CITATION LIST

### Patent Document

Patent Document 1: Japanese Published Unexamined Patent Application No. 2005-320021

### SUMMARY OF INVENTION

### Technical Problem

However, packages constituted by placing cup holders in packaging bags as described above have had the following problems. That is, in the case of packaging merchandise such as a cup-filled drink with the above-described package, a cup holder has been assembled after receipt of a customer's order and brought into a three-dimensional shape to be placed in a packaging bag.

However, it is difficult to quickly and smoothly place an assembled cup holder in a packaging bag, a packaging operation that is performed in parallel with an operation at the cash register such as checkout and thus takes a significant amount of time and effort, and particularly during busy hours, which therefore has often kept customers waiting a long time.

Further, there are also other methods such as a method of assembling a cup holder in advance to be brought into a three-dimensional shape and a method of having a cup holder brought into a three-dimensional shape ready in a manner such as to be housed in a packaging bag; however, thus-prepared articles are three-dimensional and bulky, and therefore have not been practical as measures for the above-described problems partly for the reason that a cramped store such as a convenience store is tight in space on the inside.

### Object of the Present Invention

The present invention has been made in view of the above, and an object thereof is to provide a package which can be quickly and simply brought into a three-dimensional shape from a folded state to hold a drink cup or the like and is also not bulky in storage before use, and a method for manufacturing the same.

### Solution to Problem

Means taken by the present invention to solve the above problems are as follows.

(1) The present invention is a package including a bag main body folded flat, having a gusset portion at a bottom portion, having an opening portion at a side opposite to said gusset portion, and a holder sheet folded flat, provided in parallel with the gusset portion at a position close to the bottom portion and separated from the gusset portion in an interior of said bag main body, having a single or plurality of holding opening elements.

(2) The present invention can be arranged such that the bag main body and the holder sheet are formed of a plastic film, and arranged to be attached with the holder sheet, by thermally fusion-cut portions at both widthwise sides of the bag main body and thermally welded portions of both edge portions of a side opposite to a side where the holding opening element is provided and the bag main body, integrally with the bag main body.

In this case, the package can be easily manufactured by common equipment for manufacturing a plastic film-made packaging bag, specifically, equipment provided with a sheet bending unit, a heat sealing unit, etc.

(3) The present invention can be arranged such that the holder sheet is folded into two so as to have a fold line in a direction that is parallel with a direction of the gusset portion.

In this case, because both end portions of the holder sheet are fixed across the overall length of their top-to-bottom width by the thermally welded portions or the like, when the holding opening element is made to hold a drink cup or the like, a lower portion side at both ends of the holder sheet is tensioned by a tensile force produced as a result of an opening edge portion extending as wide as possible, so that each held drink cup is further stabilized.

(4) The present invention can arrange the holding opening element so as to be bordered into a required opening shape with a weak line that enables breaking-through.

In this case, a drink container can be simply held by an opening formed by breaking through the part of the holder sheet formed by the weak line of an operator's fingers, a drink cup, or the like. Also, the part formed by the weak line, even after being broken through, usually remains connected in part without being separated, so that the generation of scrap pieces can be prevented.

(5) The present invention can also be arranged to include a handle means directly formed in the bag main body or attached to the bag main body.

In this case, a packaged drink cup or the like becomes easy to carry, which is convenient for take-out.

In addition, as the handle means, besides handle openings provided in bag main bodies, other publicly known handles can be employed, such as ones for which rope-like or band-like handles are welded on bag main bodies or ones having pinch attaching portions in lower portions of handles and being attached by pinching upper edge portions of bags therebetween.

(6) The present invention is a method for manufacturing a package including a step of forming a holding opening element in a fold line side of a two-folded sheet to form a holder sheet, a step of forming a gusset portion in a fold line side of a two-folded sheet to form a bag main body, and sandwiching the sheet formed with the holding opening element in a position separated from the gusset portion of said two-folded opposite sheets, a step of thermally welding both edge portions of a side opposite to the holding opening element of the sheet to form a holder sheet and the opposite sheets to form a bag main body, and a step of cutting by thermal fusion the sheet to form a bag main body and the sheet to forma holder sheet having been thermally welded, at a required interval in a longitudinal direction of said sheets.

(7) The present invention is a method for manufacturing a package including a step of folding a sheet to forma bag main body into two, and forming a gusset portion at a bottom portion side, a step of sandwiching a two-folded sheet to form a holder sheet in a position separated from the gusset portion of said two-folded opposite sheets, a step of thermally welding both edge portions of a side opposite to a side provided with a fold line of the sheet to form a holder sheet and the opposite sheets to form a bag main body, a step of forming a holding opening element in the fold line side of the sheet to form a holder sheet through the opposite sheets to form a bag main body, and a step of cutting by thermal fusion the sheet to form a holder sheet formed with a holding opening element and the sheet to form a bag main body at a required interval in a longitudinal direction of said sheets.

(8) The present invention is a package including a bag main body folded flat, having an opening portion, and a holder sheet folded flat, provided close to a bottom portion in an interior of said bag main body in parallel with said bottom portion, and having a holding opening element.

(Action)

Actions of the package according to the present invention will be described.

The package is not bulky in a flat folded state, and can therefore be stored in large quantities in a narrow space by stacking or the like.

When packaging drink cups (cup-filled drinks), drink containers, or the like using the package, first, the bag main body is extended from a folded state. Accordingly, the gusset portion at the bottom portion extends, the holder sheet also automatically opens concurrently therewith, and the holding opening elements of the holder sheet are brought into a state in which these can be used as holding portions for the drink cups or the like. Thus only extending the bag main body allows quickly and simply bringing the package into a three-dimensional shape that facilitates a packaging operation.

Then, the drink cups or the like are placed in the holding opening elements to keep a bottom portion of each drink cup or the like on a bag bottom formed as a result of the gusset portion of the bag main body extending such that an outer peripheral portion of each drink cup or the like closely contacts the opening edge, so as to be held by the holder sheet in the bag main body. This allows carrying the package holding the drink cups or the like in a stable state of the drink cups or the like.

### Advantageous Effects of Invention

The present invention can provide a package which can be quickly and simply brought into a three-dimensional shape from a folded state to hold a drink cup or the like and is also not bulky in storage before use, and a method for manufacturing the same.

### BRIEF DESCRIPTION OF DRAWINGS

FIG. 1 is a perspective view showing a first embodiment of a package according to the present invention.

FIG. 2 is a sectional view taken along A-A in FIG. 1.

FIG. 3 is a perspective view showing an inflated state of the package shown in FIG. 1.

FIG. 4 is an explanatory perspective view showing an inflated state of the package shown in FIG. 1 housing and retaining drink cups.

FIG. 5 is an explanatory front view showing a state of the package shown in FIG. 1 in which drink cups are housed and retained.

FIG. 6 is a sectional view taken along B-B in FIG. 5.

FIG. 7 is a perspective view showing a second embodiment of a package according to the present invention.

FIG. 8 is an explanatory view of a package manufacturing device for implementing a first method of a method for manufacturing a package according to the present invention.

FIG. 9 is an explanatory view of a package manufacturing device for implementing a second method of a method for manufacturing a package according to the present invention.

FIG. 10 is a perspective view showing a third embodiment of a package according to the present invention.

FIG. 11 is a perspective view showing a fourth embodiment of a package according to the present invention.

FIG. 12 is a perspective view of an inflated state of a package showing a fifth embodiment of a package according to the present invention.

FIG. 13 includes explanatory views showing other forms of a holding opening.

FIG. 14 includes explanatory views showing modifications of a package according to the present invention.

### DESCRIPTION OF EMBODIMENTS

The present invention will be described in detail based on embodiments shown in the drawings.

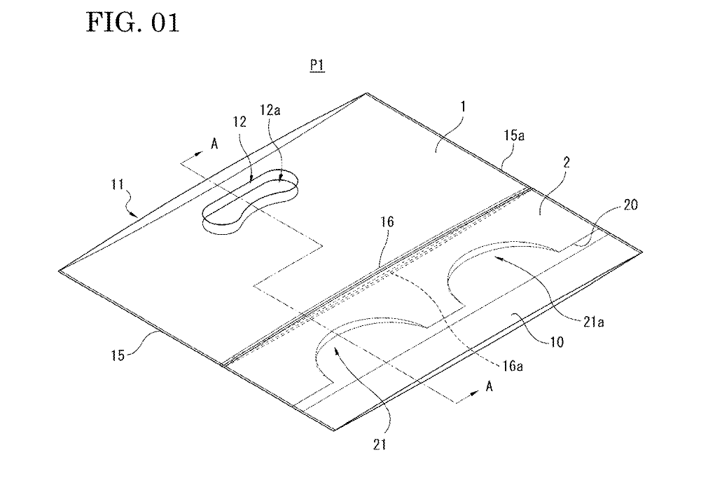

FIG. 1 to FIG. 3 will now be referred to.

A package P1 is composed of a bag main body 1 and a holder sheet 2 which are both formed of a plastic film. Regarding the bag main body 1 and the holder sheet 2, in order to facilitate an operation of making a drink cup or the like be held, the bag main body 1 is transparent while the holder sheet 2 is colored. Various color combinations can be used for these, such that both may be of the same color or transparent, or a shop logo mark may also be printed thereon.

As shown in FIG. 1, the bag main body 1 shows a rectangular shape in a flat folded state. At a side of a bottom portion (bag bottom side: lower right side in FIG. 1) of the bag main body 1, a horizontal gusset portion 10 with a required width is formed by being tucked in. Also, the bag main body 1 is opened at a side opposite to the gusset portion 10, and formed with an inlet 11. At positions close to an edge portion of opposite sheets in the inlet 11 side, slot-shaped handle holes 12 and 12a are formed.

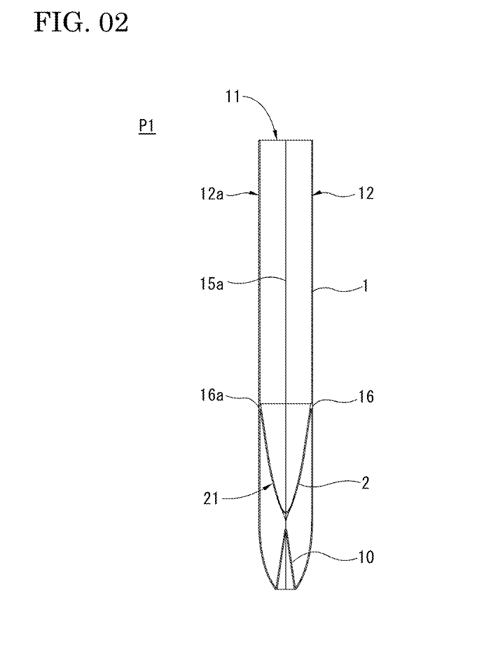

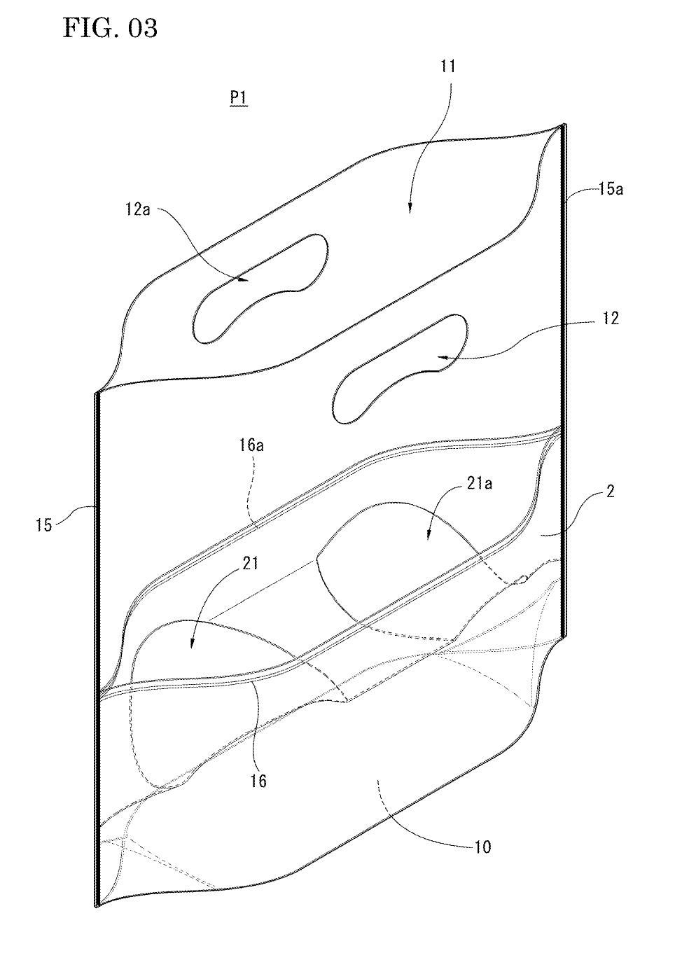

In an interior of the bag main body 1, at a position close to the bottom portion (closer to the bottom portion than to the inlet 11 at the side opposite to the bottom portion) and slightly separated from the above-described gusset portion 10, the holder sheet 2 is attached so that it is parallel with (or parallel to) the gusset portion 10. The holder sheet 2 is folded into two (refer to FIG. 1 and FIG. 2) using a side thereof close to the gusset portion 10 as a fold line 20 of a valley fold in a usage position (refer to FIG. 3).

In addition, FIG. 2 is a sectional view taken along A-A of FIG. 1, but for the sake of convenience, is a sectional view of a slightly more inflated state than the state in FIG. 1.

Also, in the fold line 20 side of the holder sheet 2, at two sites with a slight interval therebetween, holding openings 21 and 21a being holding opening elements are formed. The holding openings 21 and 21a appear in semicircular shapes in the holder sheet 2 that is in a folded state (refer to FIG. 1), and are brought into nearly circular through-openings (refer to FIG. 3) when the holder sheet 2 is opened for use.

Moreover, the holder sheet 2 is attached so as to be integrated with the bag main body 1 by thermally fusion-cut portions 15 and 15a where both widthwise sides of the bag main body 1 are cut by thermal fusion and thermally welded portions 16 and 16a where both edge portions of a side opposite to the side where the holding openings 21 and 21a are provided in the holder sheet 2 and the opposite sheets of the bag main body 1 are thermally welded across their entire width.

(Action)

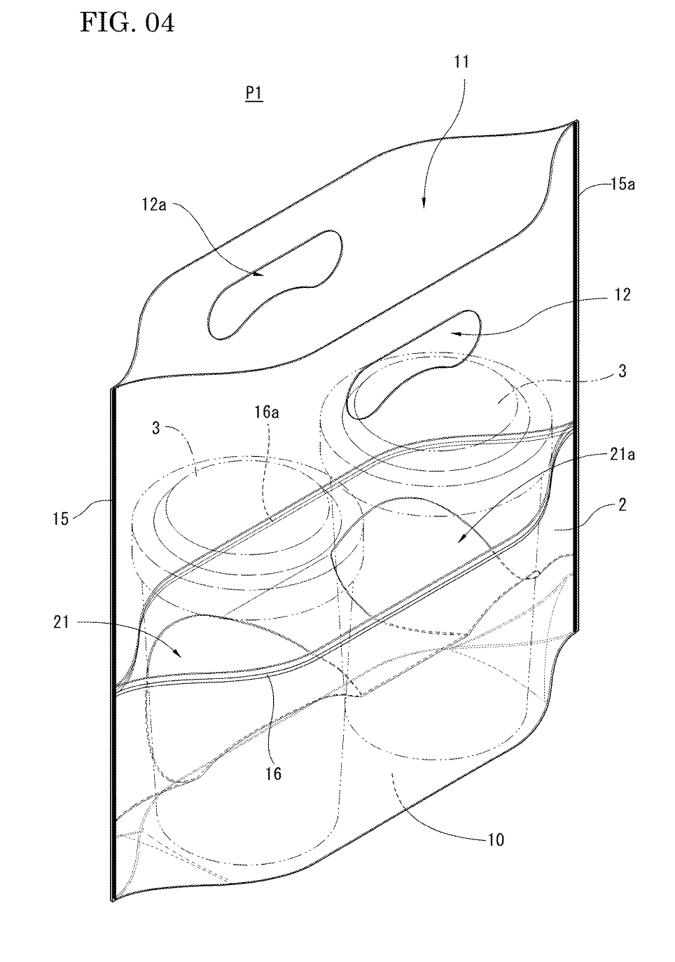

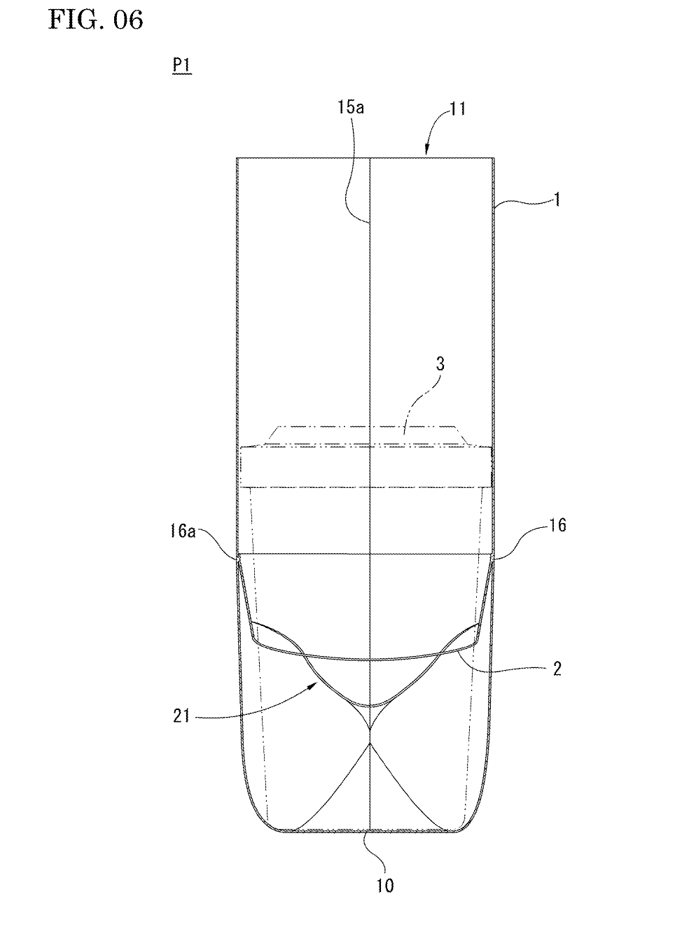

Referring to FIG. 1 to FIG. 6 and mainly to FIG. 4 to FIG. 6, actions of the package P1 will be described.

The package P1 is not bulky in a flat folded state as shown in FIG. 1, and can therefore be stored in large quantities in a narrow space by stacking or the like.

When packaging drink cups 3 using the package P1, first, the bag main body 1 is extended as shown in FIG. 3 from a folded state. Accordingly, the gusset portion 10 at the bottom portion extends, the holder sheet 2 also automatically opens concurrently therewith, and the holding openings 21 and 21a of the holder sheet 2 are formed to bring about a state in which these can be used as holding portions for the drink cups 3. Thus only extending the bag main body 1 allows quickly and simply bringing the package P1 into a three-dimensional shape that facilitates a packaging operation.

Then, the drink cups 3 are placed in the holding openings 21 and 21a to keep a bottom portion of each drink cup 3 on a bag bottom formed as a result of the gusset portion 10 of the bag main body 1 extending such that each drink cup 3 is held by the holder sheet 2 in the bag main body 1. This allows carrying the package P holding the drink cups 3 by inserting fingers into the handle holes 12 and 12a thereof.

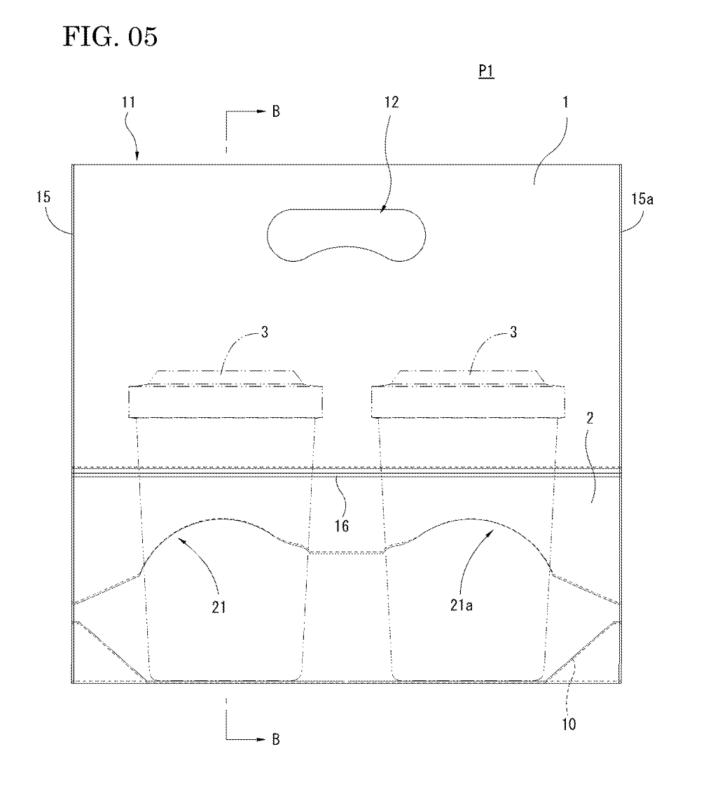

In addition, the holding opening 21, 21a has a size set such that an opening edge portion closely contacts an outer surface of the drink cup 3 when the drink cup 3 is placed in such a manner as described above. Further, because both end portions of the holder sheet 2 are welded across the overall length of their top-to-bottom width by the thermally welded portions 16 and 16a as described above, a lower portion side at both ends of the holder sheet 2 is tensioned (refer to FIG. 5) by a tensile force produced as a result of the opening edge portion of the holding opening 21, 21a extending as wide as possible, so that each held drink cup 3 is further stabilized.

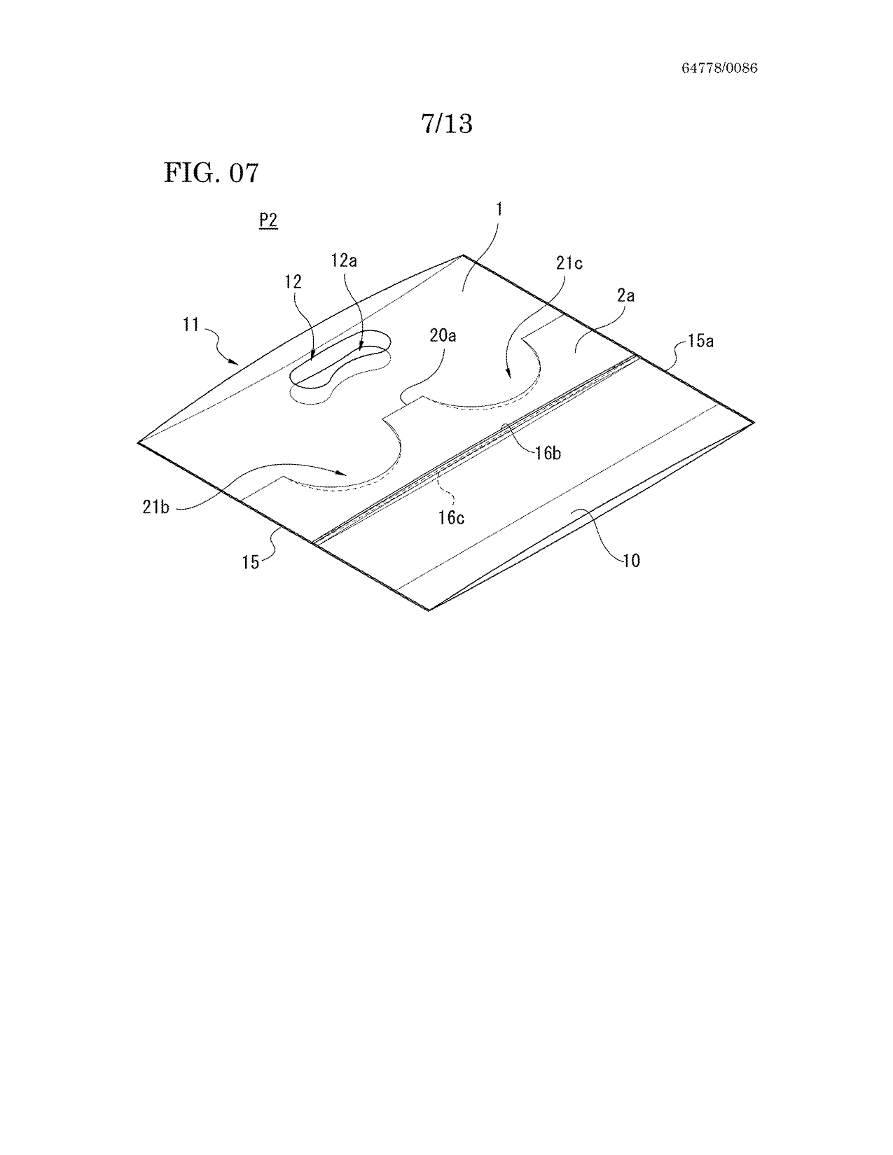

FIG. 7 will now be referred to.

The structure for attaching a holder sheet is not limited to that in the above-described package P1, and may be constituted as in a package P2. In addition, parts identical or equivalent to those of the package P1 are denoted by identical signs in FIG. 7, and overlapping descriptions regarding the structure will be omitted, and only different points will be described.

In the package P2, thermally welded portions 16b and 16c being thermally welded portions between both edge portions of a side of a holder sheet 2a opposite to the side where holding openings 21b and 21c are provided and the opposite sheets of the bag main body 1 are provided at positions similar to those of the above-described thermally welded portions 16 and 16a.

Also, the holder sheet 2a is provided with the holding openings 21b and 21c in the inlet 11 side of the bag main body 1 conversely to the above-described holder sheet 2, and a fold line 20a is structured to have a mountain fold in a usage position (refer to FIG. 3).

(Action)

According to the package P2, the point of being not bulky in a flat folded state and being able to be stored in large quantities in a narrow space by stacking or the like, the point that merely extending the bag main body 1 allows quickly and simply bringing the package into a three-dimensional shape that facilitates a packaging operation, and the point that a lower portion side at both ends of the holder sheet 2a is tensioned by a tensile force produced as a result of an opening edge portion of the holding opening 21b, 21c extending as wide as possible, so that each held drink cup 3 is further stabilized are the same as those of the above-described package P1.

With the package P2, in addition to the above-described actions, because the fold line 20a of the holder sheet 2a has a mountain fold, the holding opening 21b, 21c is located at a side close to the inlet 11 when placing the drink cup 3 in the holding opening 21b, 21c, so that the holding opening 21b, 21c opens wide at least once before having been lowered to the bottom portion side, and the holding opening 21b, 21c can therefore be easily checked, which allows more simply performing a holding operation.

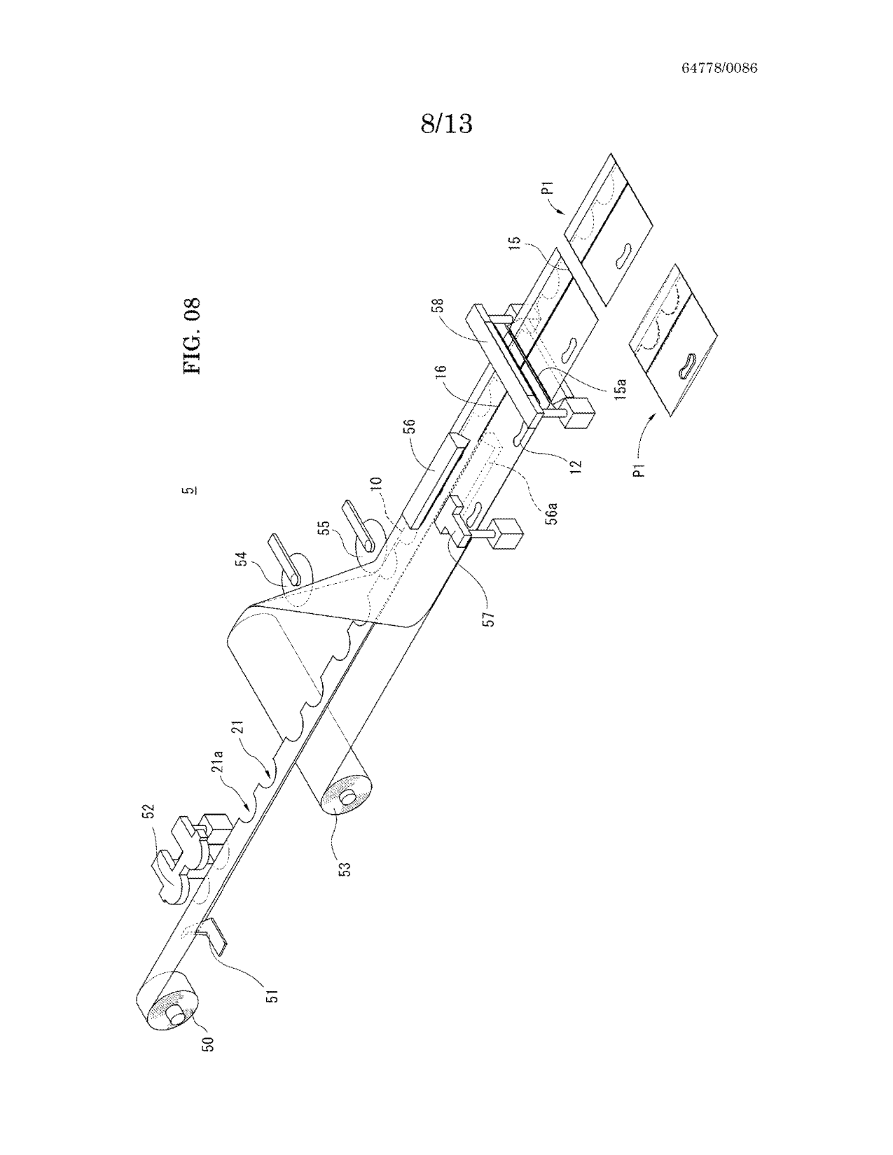

Next, referring to FIG. 8, a schematic structure of a package manufacturing device for manufacturing the above-described package P1 and a manufacturing method will be described.

The package manufacturing device 5 has a tube roll 50 set so as to allow unwinding. The tube (sign omitted) of the tube roll 50 is a plastic film-made tube to forma holder sheet 2.

In a process subsequent to the tube roll 50, a cutting blade 51 is set that cuts open the tube unwound from the tube roll 50. The cutting blade 51 cuts open the tube at a fold line part of one side thereof (a side opposite to a side where the holding openings 21 and 21a are punched out).

In a process subsequent to the cutting blade 51, a punching machine 52 is disposed that punches the tube cut open as described above at a fold line side of the other side thereof. The punching machine 52 has a half-moon-shaped cutting blade (sign omitted) that punches a fed cut-opened tube at two sites at a time in semicircular shapes to form holding openings 21 and 21a.

In a process subsequent to the punching machine 52, the package manufacturing device 5 has a sheet roll 53 set so as to allow unwinding. The sheet (sign omitted) of the sheet roll 53 is a plastic film-made sheet to form a bag main body 1.

In a process subsequent to the sheet roll 53, a half-folding machine 54 is disposed that folds the sheet unwound from the sheet roll 53 into two.

In a process subsequent to the half-folding machine 54, a gusset portion forming machine 55 is disposed that tucks in the bent side of the sheet to the inside to form a gusset portion 10.

In addition, in a part where the sheet is folded into two by the half-folding machine 54, the above-described tube formed with the holding openings 21 and 21a by the punching machine 52 is sandwiched between the opposite sheets so that it is parallel with the gusset portion 10 at a required interval therefrom.

In a process subsequent to the gusset portion forming machine 55, heat sealing machines 56 and 56a are disposed that thermally weld both edge portions of a side opposite to the holding openings 21 and 21a of the tube sandwiched as described above and the two-folded opposite sheets are thermally welded with required lengths from their front and rear sides.

Also, next to the heat sealing machines 56 and 56a, a handle hole punching machine 57 is disposed that forms by punching out handle holes 12 and 12a in the above-described opposite sheets.

In a process subsequent to the heat sealing machines 56 and 56a and the handle hole punching machine 57, a thermal fusion cutting machine 58 is disposed that cuts by thermal fusion the fed two-folded sheet and cut-open tube, at required intervals (a width of the package P1) in a direction in which these are fed, in a direction perpendicular to the direction of feeding.

A method for manufacturing a package P1 using the above-described package manufacturing device 5 is as follows.

(1) A tube that is unwound from the tube roll 50 to form a holder sheet 2 is cut open by the cutting blade 51. In addition, the thus cut-open tube cannot be strictly said to be a tube, but for the sake of convenience, this will be continuously described as a tube.

(2) The tube is punched at a fold line side of the side opposite to a side where the tube was cut open in semicircular shapes by the punching machine 52 to form holding openings 21 and 21a.

(3) In a step subsequent to the punching machine 52, a sheet unwound from the sheet roll 53 is folded into two by the half-folding machine 54, and the bent side of the sheet is tucked in to the inside by the gusset portion forming machine 55 to form a gusset portion 10.

(4) Also, in a part where the sheet is folded into two by the half-folding machine 54, the tube formed with the holding openings 21 and 21a by the punching machine 52 is sandwiched between the opposite sheets so that it is parallel with the gusset portion 10 at a required interval therefrom.

(5) In a process subsequent to the gusset portion forming machine 55, both edge portions of a side opposite to the holding openings 21 and 21a of the sandwiched tube and the two-folded opposite sheets are thermally welded with required lengths from their front and rear sides by the heat sealing machines 56 and 56a to form thermally welded portions 16 and 16a. Also, the handle holes 12 and 12a are formed by being punched out in opposite sheets by the handle hole punching machine 57.

(6) In a process subsequent to the heat sealing machines 56 and 56a and the handle hole punching machine 57, the two-folded sheet and the cut-open tube are cut by thermal fusion using the thermal fusion cutting machine 58, at required intervals (a width of the package P1) in a direction in which these are fed, in a direction perpendicular to the direction of feeding to form thermally fusion-cut portions 15 and 15a. The two-folded sheet (to serve as a bag main body 1) and the cut-open tube (to serve as a holder sheet 2) are thus integrated via the thermally welded portions 16 and 16a and the thermally fusion-cut portions 15 and 15a to form a package P1.

In addition, by slightly shifting a feeding position of the tube to form a holder sheet to the side where handle holes are formed and further by providing the side to form holding openings 21b and 21c in the tube as a side opposite to that by the above-described package manufacturing device 5 (a side close to the handle holes 12 and 12a), the package manufacturing device can also be provided as a device for manufacturing the above-described package P2.

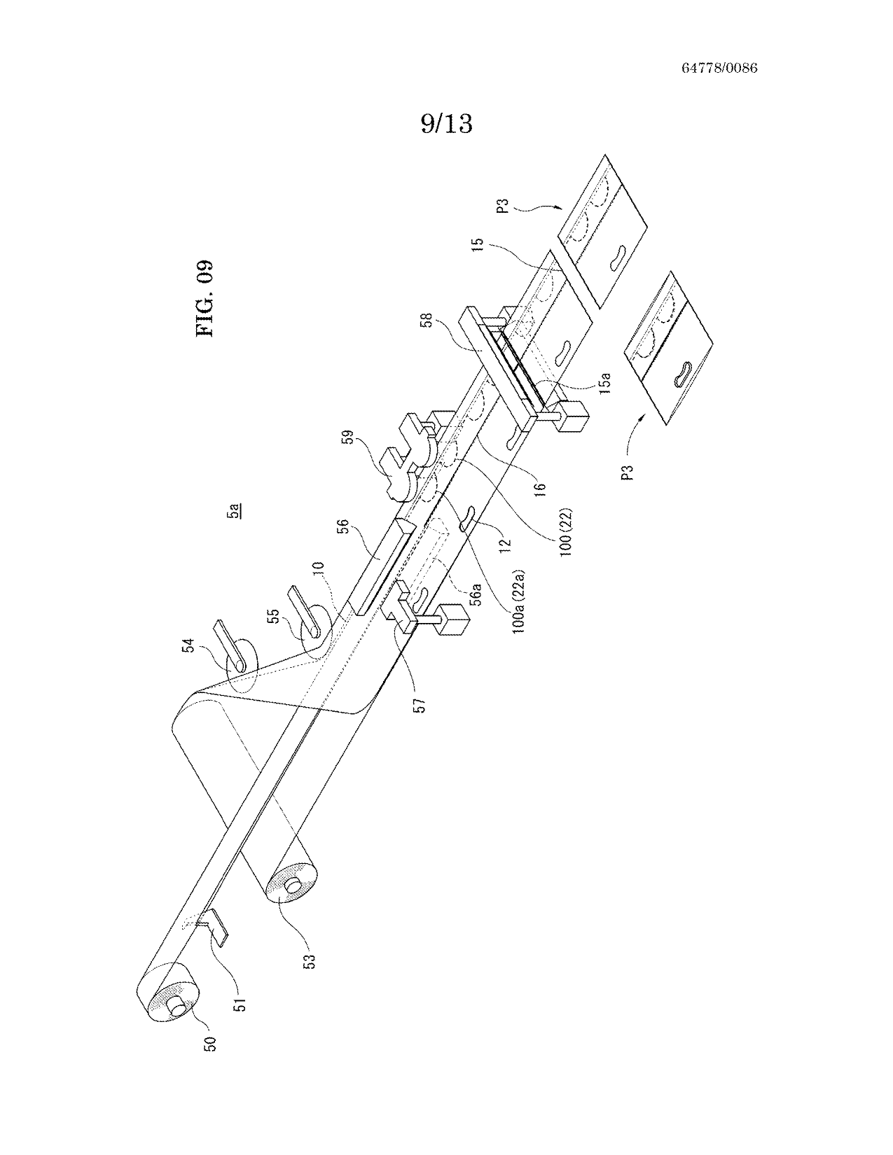

Referring to FIG. 9, a schematic structure of a package manufacturing device for manufacturing a package P3 to be described later and a manufacturing method will be described.

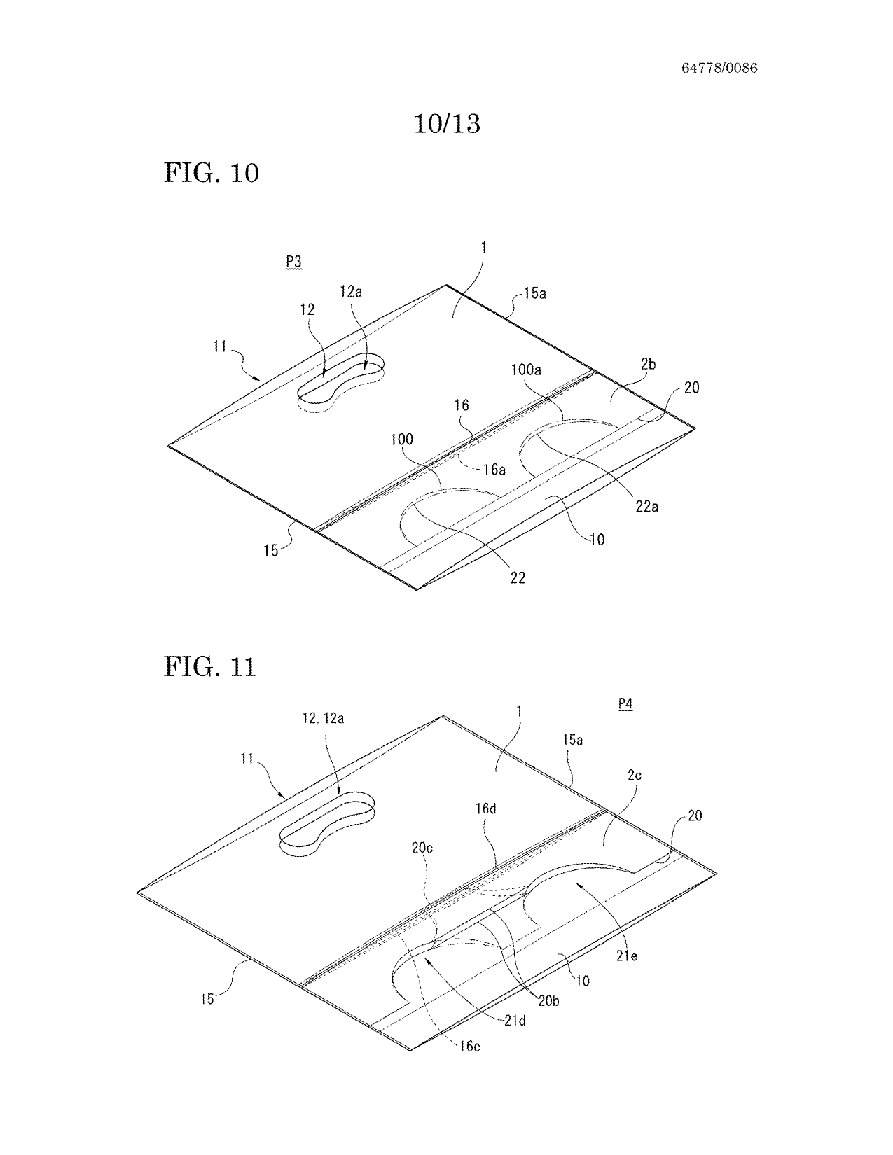

The package manufacturing device 5a has a tube roll 50 set so as to allow unwinding. The tube (sign omitted) of the tube roll 50 is a plastic film-made tube to form a holder sheet 2b (refer to FIG. 10).

In a process subsequent to the tube roll 50, a cutting blade 51 is set that cuts open the tube unwound from the tube roll 50. The cutting blade 51 cuts open the tube at a fold line part of one side thereof (a side opposite to a side where weak lines 22 and 22a (refer to FIG. 10) are punched out).

In a process subsequent to the cutting blade 51, the package manufacturing device 5a has a sheet roll 53 set so as to allow unwinding. The sheet (sign omitted) of the sheet roll 53 is a plastic film-made sheet to form a bag main body 1.

In a process subsequent to the sheet roll 53, a half-folding machine 54 is disposed that folds the sheet unwound from the sheet roll 53 into two.

In a process subsequent to the half-folding machine 54, a gusset portion forming machine 55 is disposed that tucks in the bent side of the sheet to the inside to forma gusset portion 10.

In addition, in a part where the sheet is folded into two by the half-folding machine 54, the above-described tube cut open at the fold line part of one side thereof is sandwiched between the opposite sheets so that it is parallel with the gusset portion 10 at a required interval therefrom.

In a process subsequent to the gusset portion forming machine 55, heat sealing machines 56 and 56a are disposed that thermally weld both edge portions of a side opposite to the weak lines 22 and 22a of the tube sandwiched as described above and the two-folded opposite sheets are thermally welded with required lengths from their front and rear sides.

Also, next to the heat sealing machines 56 and 56a, a handle hole punching machine 57 is disposed that forms by punching out handle holes 12 and 12a in the above-described opposite sheets.

In a process subsequent to the heat sealing machines 56 and 56a and the handle hole punching machine 57, a weak line forming machine 59 is disposed that forms semicircular weak lines 22 and 22a and 100 and 100a (refer to FIG. 10) formed by perforations in the cut-open tube and the opposite sheets sandwiching the same. The weak line forming machine 59 has a semicircular discontinuous cutting blade (sign omitted) to form weak lines 22 and 22a and 100 and 100a in the cut-open tube and the opposite sheets sandwiching the same.

In a process subsequent to the weak line forming machine 59, a thermal fusion cutting machine 58 is disposed that cuts by thermal fusion the fed cut-open tube and two-folded opposite sheets sandwiching the same, at required intervals (a width of the package P3) in a direction in which these are fed, in a direction perpendicular to the direction of feeding.

A method for manufacturing a package P3 using the above-described package manufacturing device 5a is as follows.

(1) A tube that is unwound from the tube roll 50 to form a holder sheet 2b is cut open by the cutting blade 51. In addition, the thus cut-open tube cannot be strictly said to be a tube, but for the sake of convenience, this will be continuously described as a tube.

(2) In a step subsequent to the cutting blade 51, a sheet unwound from the sheet roll 53 is folded into two by the half-folding machine 54, and the bent side of the sheet is tucked in to the inside by the gusset portion forming machine 55 to form a gusset portion 10.

(3) Also, in a part where the sheet is folded into two by the half-folding machine 54, the cut-open tube is sandwiched between the opposite sheets so that it is parallel with the gusset portion 10 at a required interval therefrom.

(4) In a process subsequent to the gusset portion forming machine 55, both edge portions of a side of the sandwiched tube opposite to the side where the weak lines 22 and 22a are formed and the two-folded opposite sheets are thermally welded with required lengths from their front and rear sides by the heat sealing machines 56 and 56a to form thermally welded portions 16 and 16a. Also, the handle holes 12 and 12a are formed by being punched out in opposite sheets by the handle hole punching machine 57.

(5) In a process subsequent to the heat sealing machines 56 and 56a and the handle hole punching machine 57, semicircular weak lines 22 and 22a and 100 and 100a formed by perforations by a weak line forming machine 59 are formed in the cut-open tube and the two-folded opposite sheets. In addition, the weak lines 22 and 22a and 100 and 100a are provided on both front and rear sides of the package P3, and are located at two sites each on the front and rear in a folded state, for a total of eight sites.

(6) In a process subsequent to the weak line forming machine 59, the cut-open tube and the two-folded opposite sheets are cut by thermal fusion using the thermal fusion cutting machine 58, at required intervals (a width of the package P3) in a direction in which these are fed, in a direction perpendicular to the direction of feeding to form thermally fusion-cut portions 15 and 15a. The cut-open tube (to serve as a holder sheet 2b) and the two-folded sheets (to serve as a bag main body 1) are thus integrated via the thermally welded portions 16 and 16a and the thermally fusion-cut portions 15 and 15a to form a package P3.

Referring to FIG. 10, the package P3 manufactured by the method for manufacturing a package described with reference to FIG. 9 described above will be described. In addition, parts identical or equivalent to those of the above-described package P1 are denoted by identical signs in FIG. 10, and overlapping descriptions regarding the structure will be omitted, and only different points will be described.

In the fold line 20 side of the holder sheet 2b and the opposite sheets of the bag main body 1 sandwiching the holder sheet 2b, at two sites of mutually overlapping positions, semicircular weak lines 22 and 22a and 100 and 100a formed by perforations are formed. The weak lines 22 and 22a in the holder sheet 2b are formed such that both ends reach the fold line 20. The weak lines 100 and 100a in the bag main body 1 are formed for the sake of convenience in order to form the weak lines 22 and 22a in the holder sheet 2b.

(Action)

The package P3 is the same as the above-described package P1 in the point of being not bulky in a flat folded state and being able to be stored in large quantities in a narrow space by stacking or the like, in the point that merely extending the bag main body 1 allows quickly and simply bringing the package into a three-dimensional shape that facilitates a packaging operation, and in the point that a lower portion side at both ends of the holder sheet 2b is tensioned by a tensile force produced as a result of an opening edge portion of the holding opening extending as wide as possible, so that each held drink cup 3 is further stabilized.

Also, the package P3 can, by holding openings (not shown) formed by breaking through the part of the holder sheet 2b formed by the weak lines 22 and 22a with an operator's fingers or drink cups 3, simply hold the drink cups 3. Also, the part formed by the weak lines 22 and 22a, even after being broken through, usually remains connected in part without being separated, so that the generation of scrap pieces can be prevented.

In addition, if the holder sheet is punched in order to form holding openings therein together with the opposite sheets of the bag main body sandwiching the holder sheet, a large amount of scrap pieces are produced in manufacturing, and the strength of the bag main body may possibly be compromised as a result of openings being formed in the punched part. In contrast thereto, the bag main body 1 of the package P3 includes only the weak line 100 and 100a, and is not formed with openings to weaken the strength, and therefore, the package P3 can solve the problems.

FIG. 11 will now be referred to.

A holder sheet of a package may have a structure such as that of a package P4. In addition, parts identical or equivalent to those of the package P1 are denoted by identical signs in FIG. 11, and overlapping descriptions regarding the structure will be omitted, and only different points will be described.

In the package P4, thermally welded portions 16d and 16e being thermally welded portions between both edge portions of a side of a holder sheet 2c opposite to the side where holding openings 21d and 21e are provided and the opposite sheets of the bag main body 1 are provided at positions similar to those of the above-described thermally welded portions 16 and 16a.

Also, in the holder sheet 2c, the part (part shown by imaginary lines) between the holding openings 21d and 21e is folded up so as to become inside out from the state of the holder sheet 2 of the package P1. That is, a constitution is provided in that the part between the holding openings 21d and 21e is bent to the inside along lines connecting the bottoms of arcs of the holding openings 21d and 21e used as fold lines 20b, and is bent reversely using a middle portion as a fold line 20c to be folded.

According to the package P4, when the bag main body 1 is opened for use, because a part of the opening edge portions of the holding openings 21d and 21e, that is, apart corresponding to the above-described part folded up inside out (part shown by dotted lines) is located at an upper side (a side close to the inlet 11) as compared to the holder sheet 2 of the package P1, cups 3 can be easily fitted to the holding openings 21d and 21e to be easily contained.

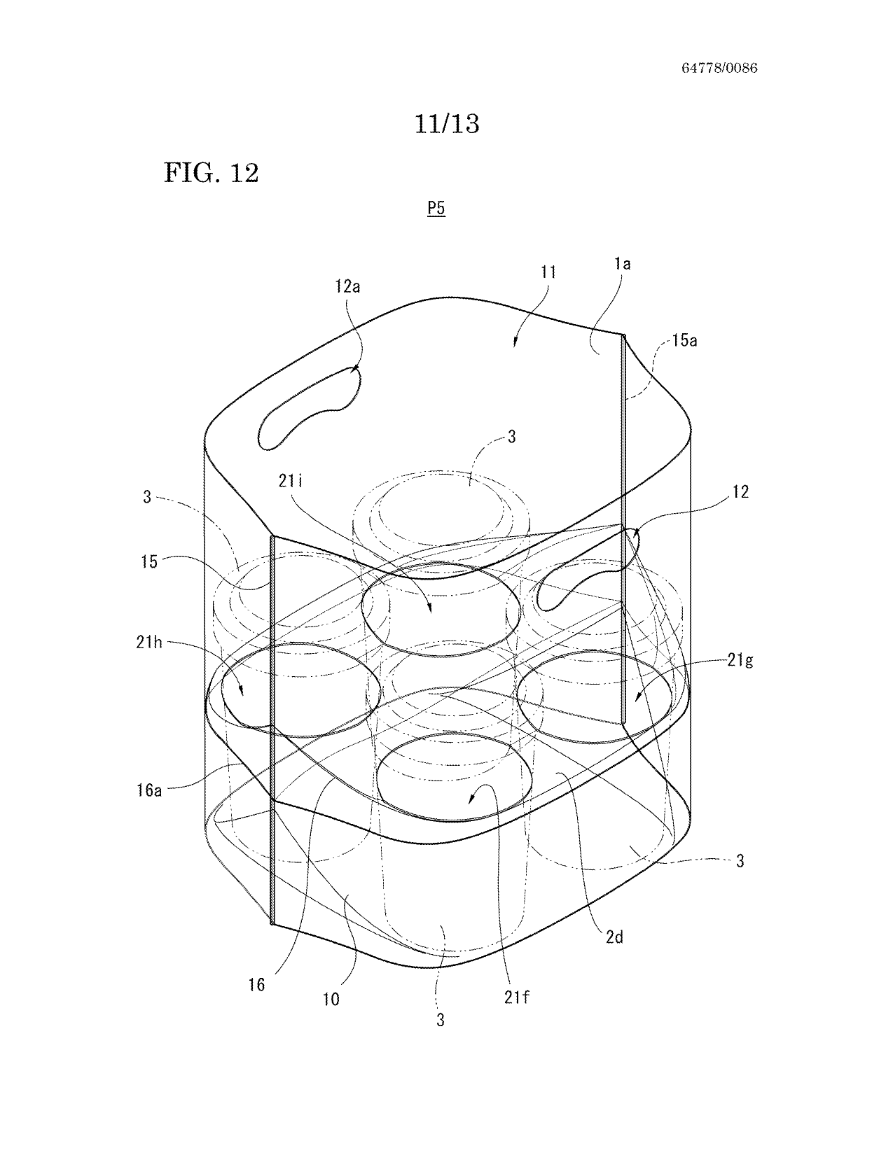

FIG. 12 will now be referred to.

A holder sheet of a package may have a structure such as that of a package P5. In addition, parts identical or equivalent to those of the package P1 are denoted by identical signs in FIG. 12, and overlapping descriptions regarding the structure will be omitted, and only different points will be described.

In the package P5, a holder sheet 2d has a structure in which two holder sheets each having the same structure as that of the holder sheet 2 of the package P1 are first stacked in a thickness direction, end edge portions at a contact side of these holder sheets are made continuous into a bellows shape, and further, end edge portions at a side opposite to the connection side are thermally welded to a bag main body 1a similarly to those in the package P1. Accordingly, the holder sheet 2d has an area approximately two times that of the holder sheet 2 of the package P1 when extended, and holding openings 21f, 21g, 21h, and 21i are formed at a total of four sites.

According to the package P5, when the bag main body 1a is opened for use, the bag main body 1a is widely extended, and the holder sheet 2d is also accordingly extended, so that the four holding openings 21f, 21g, 21h, and 21i are formed. The package P5 allows carrying four cups 3 contained therein, which is efficient and convenient.

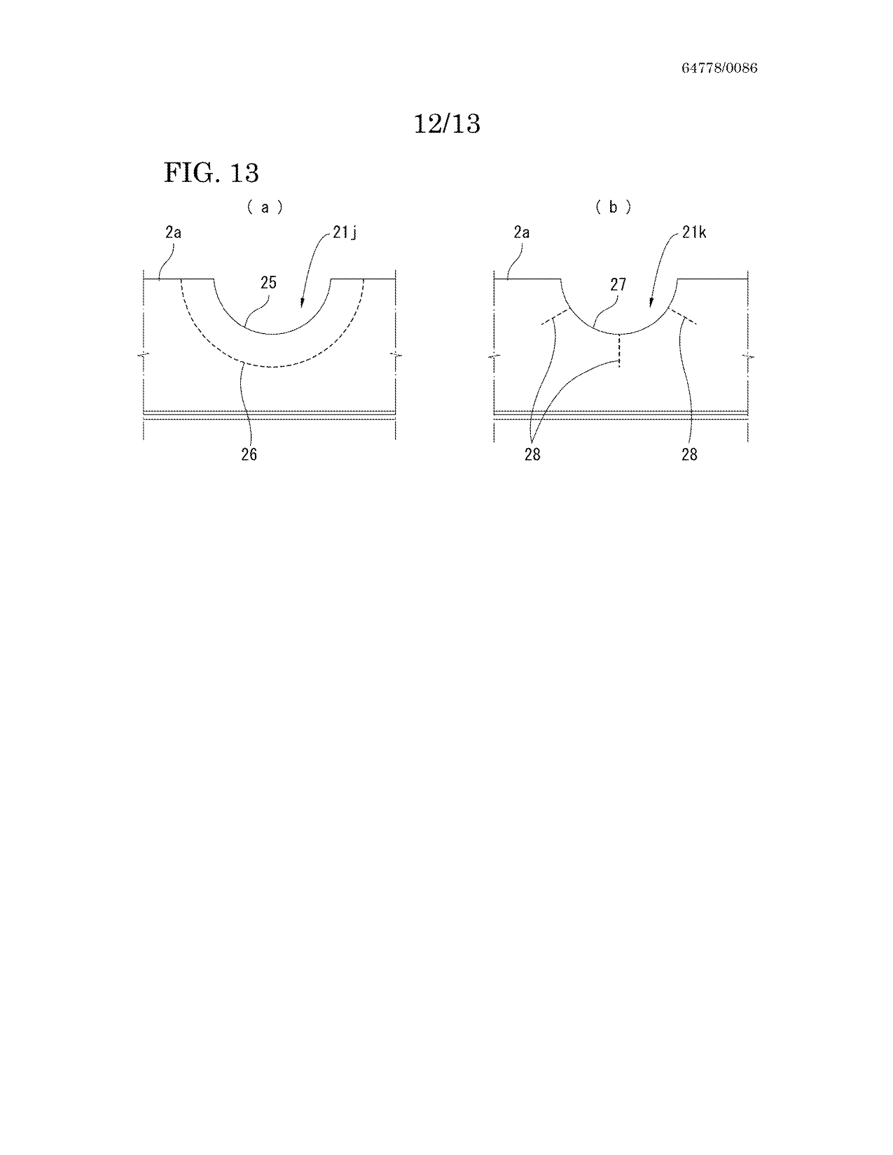

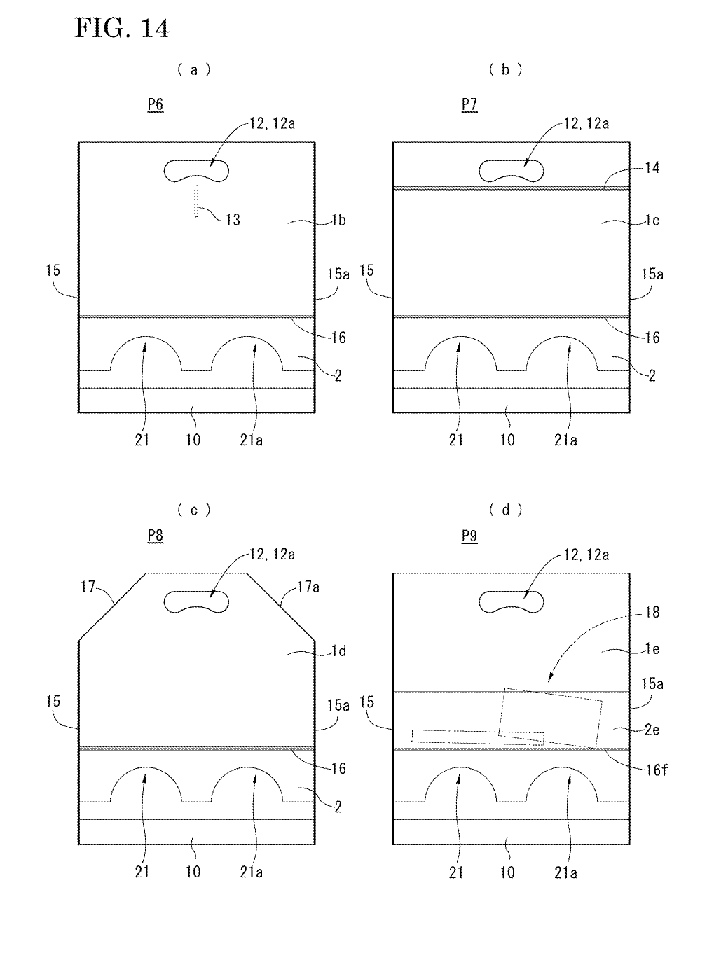

FIG. 13 will now be referred to.

The holding openings to be provided in each holder sheet (for the sake of convenience, denoted by sign 2a) are not limited to simple circular openings as described above, and may be in, for example, oval shapes that are longer in the extending direction of the holder sheet. In this case, because the holding openings have a slight clearance at their opening edges and the opening edges are therefore not tensioned even when cups 3 are contained, there is an advantage of easily being contained.

The holding opening 21j shown in FIG. 13(a) is compatible with cups of two sizes. The holding opening 21j is composed of a hole 25 with a small diameter and weak lines 26 formed by perforations that form large-diameter arcs concentric with the hole 25.

And, for containing a cup with a small diameter, the hole 25 is used as it is as a holding opening. On the other hand, for containing a cup with a large diameter, a holding hole with a large diameter (not shown, sign omitted) is formed by tearing off along the weak line 26 of perforation, and the hole is used as a holding opening.

Also, the holding opening 21k shown in FIG. 13(b) is compatible with cups of various sizes. The holding opening 21k is composed of a hole 27 with a small diameter and weak lines 28 formed by perforations provided with a required length radially from a hole edge of the hole 27 and at a plurality of sites at required intervals circumferentially.

Moreover, for containing a cup with a small diameter, the hole 27 is used as it is as a holding opening. On the other hand, for containing a bigger cup, the respective weak lines 28 are torn apart up to points that correspond to the cup size by containing a cup 3 in a manner of pushing and breaking through along the respective weak lines 28 with a cup bottom thereof or in such a manner as making cuts in the respective weak lines 28, and it is therefore possible to contain cups with different sizes up to the maximum diameter by the respective weak lines 28.

In addition, in the holder sheet 2a shown in FIG. 13, the holding openings 21j and 21k are provided in the inlet 11 side of the holder sheet 2a similarly to the above-described packaging bag P2 (refer to FIG. 7). This provides an advantage that, in such a case of, for example, tearing off the hole edge along the weak lines 26 or making cuts in the weak lines 28, the operation is facilitated for being close to the inlet 11. Also, a holding opening provided with such weak lines may also be provided on a side distant from (a side opposite to) the inlet 11 as in the holder sheet 2 of the packaging bag P1 (refer to FIG. 1).

FIG. 14 will now be referred to. In FIG. 14, a modification of a package according to the present invention is shown. In addition, parts identical or equivalent to those of the package P1 are denoted by identical signs in FIG. 14, and overlapping descriptions regarding the structure will be omitted, and only different points will be described.

The package P6 shown in FIG. 14 (a) has a structure in which both sheets of a bag main body 1b are welded at a thermal welding line 13 provided under the handle holes 12 and 12a.

According to this, even when the bag main body 1b is extended for use, there is provided a closed state near the handles 12 and 12a, so that when, for example, a vertically long cup is contained, the cup is stabilized, which is therefore convenient.

The package P7 shown in FIG. 14 (b) has a structure in which a rail fastener 14 is provided under the handle holes 12 and 12a of a bag main body 1c.

According to this, because an upper part of the bag main body 1c can be closed with the rail fastener 14 according to necessity after containing a cup, it is possible to carry the cup in a sanitary manner.

The package P8 shown in FIG. 14 (c) has a structure of having cut-away portions 17 and 17a in which opposite corner portions in an upper portion of a bag main body 1d are cut away at an angle of 45°.

According to this, when the bag main body 1d is extended to place a cup in an interior thereof, the corner portions do not become an obstruction as in the package P1, and there is an advantage in that the containing operation is easy to perform.

The package P9 shown in FIG. 14(d) has a holder sheet 2e that is made long in its top-to-bottom direction (approximately two times as long as the holder sheet 2 of the package P1), and a thermally welded portion 16f is provided at a middle portion thereof. Due to this structure, on an inner surface side of the bag main body 1e, at two sites of both sheet sides in an upper portion side of the holder sheet 2e, pockets 18 having a thermally welded portion 16f as their bottom are formed.

According to this, the pockets 18 can be used as portions to contain straws, chopsticks, or napkins, which is therefore convenient.

The terms and expressions used in the present specification are merely descriptive and not restrictive by any means, and there is no intention of excluding any terms and expressions equivalent to the features described in the present specification and portions thereof.

### REFERENCE SIGNS LIST

P1 package; 1 bag main body; 10 gusset portion; 11 inlet; 12, 12a handle hole; 15, 15a thermally fusion-cut portion; 16, 16a thermal weld; 2 holder sheet; 20 fold line; 21, 21a holding opening;
P2 package; 2a holder sheet; 20a fold line; 21b, 21c holding opening; 16b, 16c thermally welded portion;
P3 package; 2b holder sheet; 22, 22a weak line; 100, 100a weak line;
5 package manufacturing device;
50 tube roll; 51 cutting blade; 52 punching machine; 53 sheet roll; 54 half-folding machine; 55 gusset portion forming machine; 56, 56a heat sealing machine; 57 handle hole punch;
58 thermal fusion cutting machine;
5a package manufacturing device;
50 tube roll; 51 cutting blade; 53 sheet roll; 54 half-folding machine; 55 gusset portion forming machine; 56, 56a heat sealing machine; 57 handle hole punching machine; 58 thermal fusion cutting machine; 59 weak line forming machine;
P4 package; 2c holder sheet; 21d, 21e holding opening; 16d,
16e thermally welded portion; 20b fold line; 20c fold line;
P5 package; 2d holder sheet; 1a bag main body; 21f, 21g, 21h, 21i holding opening; 25 hole; 26 weak line; 21k holding opening; 27 hole; 28 weak line;
P6 package; 1b package main body; 13 thermal welding line;
P7 package; 1c package main body; 14 rail fastener;
P8 package; 1d package main body; 17, 17a cut-away portion;
P9 package; 2e holder sheet; 16f thermally welded portion; 1e main body; 18 pocket;

1: A package comprising:
a bag main body folded flat, having a gusset portion at a bottom portion, and having an opening portion at a side opposite to said gusset portion; and
a holder sheet folded flat, provided in parallel with the gusset portion at a position close to the bottom portion and separated from the gusset portion in an interior of said bag main body, having a single or plurality of holding opening elements;
wherein the bag main body and the holder sheet are formed of a plastic film, and the holder sheet is, by thermally fusion-cut portions at both widthwise sides of the bag main body and thermally welded portions of both edge portions of a side opposite to a side where the holding opening element is provided and the bag main body, attached integrally with the bag main body.

2. (canceled)

3: The package according to claim 1, wherein the holder sheet is folded into two so as to have a fold line in a direction that is parallel with a direction of the gusset portion.

4: The package according to claim 1, wherein the holding opening element has a structure bordered into a required opening shape with a weak line that enables breaking-through.

5: The package according to claim 1, further comprising handle means directly formed in the bag main body or attached to the bag main body.

6: A method for manufacturing a package comprising:
a step of forming a holding opening element in a fold line side of a two-folded sheet to form a holder sheet;
a step of forming a gusset portion in a fold line side of a two-folded sheet to form a bag main body, and sandwiching the sheet formed with the holding opening element in a position separated from the gusset portion of said two-folded opposite sheets;
a step of thermally welding both edge portions of a side opposite to the holding opening element of the sheet to form a holder sheet and the opposite sheets to form a bag main body; and
a step of cutting by thermal fusion the sheet to form a bag main body and the sheet to form a holder sheet having been thermally welded, at a required interval in a longitudinal direction of said sheets.

7: A method for manufacturing a package comprising:
a step of folding a sheet to form a bag main body into two, and forming a gusset portion at a bottom portion side;
a step of sandwiching a two-folded sheet to form a holder sheet in a position separated from the gusset portion of said two-folded opposite sheets;
a step of thermally welding both edge portions of a side opposite to a side provided with a fold line of the sheet to form a holder sheet and the opposite sheets to form a bag main body;
a step of forming a holding opening element in the fold line side of the sheet to form a holder sheet through the opposite sheets to form a bag main body; and
a step of cutting by thermal fusion the sheet to form a holder sheet formed with a holding opening element and the sheet to form a bag main body at a required interval in a longitudinal direction of said sheets.

8. (canceled)

9: The package according to claim 3, wherein the holding opening element has a structure bordered into a required opening shape with a weak line that enables breaking-through.

10: The package according to claim 3, further comprising handle means directly formed in the bag main body or attached to the bag main body.

11: The package according to claim 4, further comprising handle means directly formed in the bag main body or attached to the bag main body.

12: The package according to claim 9, further comprising handle means directly formed in the bag main body or attached to the bag main body.
